(19) United States
(12) Patent Application Publication
(10) Pub. No.: US 2016/0055494 A1
(43) Pub. Date: Feb. 25, 2016

(54) BOOKING BASED DEMAND FORECAST

(71) Applicants: Boyi Ni, Jiangsu (CN); Ruijiang Li, Shanghai (CN); Wenyu Dong, Shanghai (CN); Xingtian Shi, Shanghai (CN); Philippe Nemery, Shanghai (CN); Terry Wang, Shanghai (CN); Irene Chen, Shanghai (CN); Mark Finch, Walnut Creek, CA (US); Harald Hengelbrock, Heidelberg (DE)

(72) Inventors: Boyi Ni, Jiangsu (CN); Ruijiang Li, Shanghai (CN); Wenyu Dong, Shanghai (CN); Xingtian Shi, Shanghai (CN); Philippe Nemery, Shanghai (CN); Terry Wang, Shanghai (CN); Irene Chen, Shanghai (CN); Mark Finch, Walnut Creek, CA (US); Harald Hengelbrock, Heidelberg (DE)

(21) Appl. No.: 14/463,199

(22) Filed: Aug. 19, 2014

(51) Int. Cl. G06Q 30/02; G06Q 10/02

(52) U.S. Cl. CPC G06Q 30/0202; G06Q 10/02

(57) ABSTRACT

A computer-implemented method for a booking based demand forecast problem includes converting time series data into a multivariate time series, training a multivariate time series model using the converted multivariate time series, forecasting results using the multivariate time series model and aggregating the results.

### TECHNICAL FIELD

This description relates to booking based demand forecast.

### BACKGROUND

Demand forecast plays a role in various domains including, for instance, supply chain management and transportation system, where demand forecast provides a basis for operational planning and strategic decisions. For example, in the transportation management system, in order to increase the utilization of the transportation assets (truck, trailer, vessel, etc.), the transportation plan should be optimized and short-/long-term assets repositioning will be executed. Accurate demand forecast (demand for transportation assets) is harnessed and used to better envision the future plan horizon so as to get the global optimal solutions.

### SUMMARY

According to one general aspect, a computer-implemented method for a booking based demand forecast problem includes converting time series data into a multivariate time series, training a multivariate time series model using the converted multivariate time series, forecasting results using the multivariate time series model and aggregating the results.

In another general aspect, a computer program product for a booking based demand forecast problem is tangibly embodied on a non-transitory computer-readable storage medium and includes instructions that, when executed by at least one computing device, are configured to cause the at least one computing device to convert time series data into a multivariate time series, train a multivariate time series model using the converted multivariate time series, forecast results using the multivariate time series model and aggregate the results.

In another general aspect, a system for a booking based demand forecast problem includes at least one memory including instructions and at least one processor that is operably coupled to the at least one memory and that is arranged and configured to execute the instructions that, when executed, cause the at least one processor to implement a time series converter, a multivariate times series model, a forecast engine, and an aggregator. the time series converter is configured to convert time series data into a multivariate time series. The multivariate time series model is configured to be trained using the converted multivariate time series. The forecast engine is configured to forecast results using the multivariate time series model. The aggregator is configured to aggregate the results.

The details of one or more implementations are set forth in the accompanying drawings and the description below. Other features will be apparent from the description and drawings, and from the claims.

### BRIEF DESCRIPTION OF THE DRAWINGS

FIG. 1 is an example database of customer bookings

FIG. 2 is an example chart of customer booking in aggregated form from the database of FIG. 1.

FIG. 3 is an example chart of aggregated forecast results.

FIG. 4 is an example flowchart illustrating a process for booking forecast.

FIG. 5 is an example flowchart illustrating a Bayesian online update for booking forecast.

FIG. 6 is a block diagram of a system for booking based demand forecast.

### DETAILED DESCRIPTION

This document describes systems and techniques for a forecast system related to booking-based business, where the booking-based demand forecast problem is modeled with consideration of the business logic and external influencing factors. A multivariate time series model is applied to one or more vectors of multivariate time series data that takes into account the business logic and external factors. One or more different types of multivariate time series models may be selected and used to provide flexibility. In one example implementation, a Dynamic Linear Model (DLM) may be used for the multivariate time series model. In this manner, re-estimation of the multivariate time series model may be avoided when new booking data is received. Furthermore, an online update strategy is implemented with a Bayesian paradigm such that a real time forecast update based on incoming bookings is possible.

In brief, two categories of the forecast methods may be utilized in the real business world: statistical forecasting and non-statistical forecasting. Non-statistical forecast may rely on human domain knowledge and qualitative assessment like market research. Non-statistical forecast could be used for strategic forecast but lacks a capability to react to the operational change and to estimate accurate numbers.

Statistical forecast methods build forecast models based on historical demand data and statistical or machine learning theories. Generally, statistical methods may be more stable and easier to adapt to different business scenarios than non-statistical forecast methods. For short-/tactical-term planning, statistical methods are more adopted than non-statistical methods. The statistical methods may form the demand forecast problem as to predict the <time; value> pair based on historical data, which also may be modeled as series data. Time series analysis like smoothing/projection techniques and regression depends on this assumption.

The above describes a simplified model and some aspects may not be incorporated into such a statistical model. For example, in a real business scenario, customers usually first make a booking and ask the manufacturer (service provider) to deliver the good (service) within a limited horizon of ahead-time. When new bookings come in or former bookings are cancelled, they are good indicators of the future demand. The forecast method should be able to automatically update the prediction based on the change within a relatively short time. This can be of key business value to the company, as an accurate forecast can maximize utilization of assets and minimize loss of orders due to low inventory, as well as minimize relocation costs between stocks. However, the simple <time; value> solution may be unable to handle this type of real business scenario.

Additionally, business logic may not easily be integrated into the simplified statistical model. For example, in real business, over-booking may be used, where over-booking means there is an accepted booking cancellation rate in the real business. In the <time; value> model, a cancellation rate can only be used as a constant smoother in the time series. More complex business logic cannot be applied.

Finally, many other factors like economy data, weather, traffic conditions, holiday, and promotion may be ignored. Lacking the information could lead to untrusted even wrong forecast. This also means the prediction is static and valuable simulation like what-if analysis is not applicable in the simplified model.

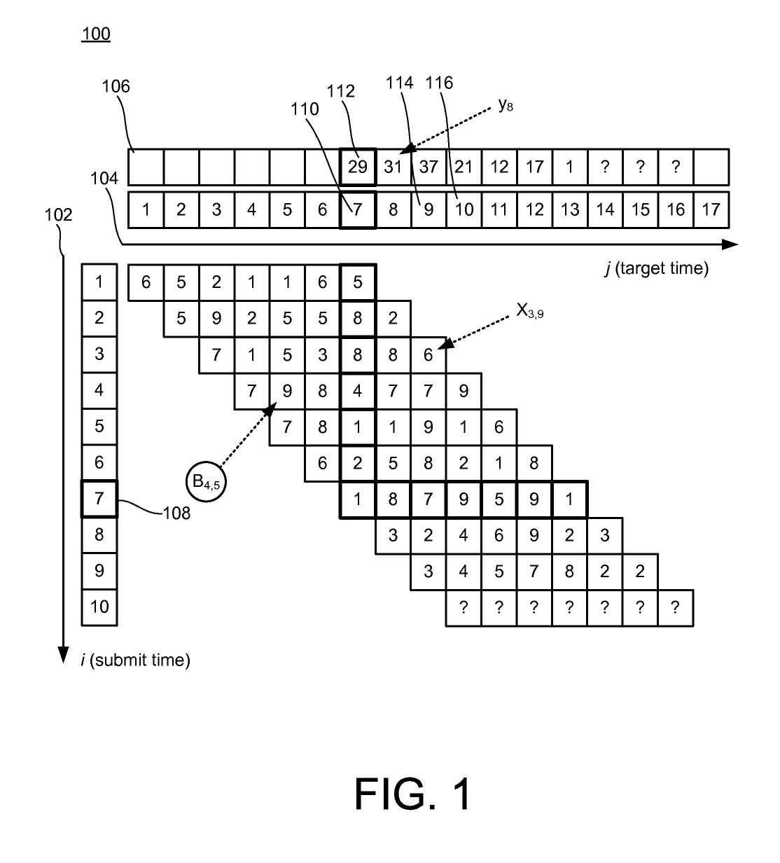

Referring to FIG. 1, an example database 100 illustrates an example booking scenario. Customer bookings are acceptable within a limited horizon of ahead-time. The total demand at the target time will be collected from the bookings submitted in advance. The future demand at a specific target time can be partly known from the booking records, while customers might continue to send new bookings, change, or cancellation to the company until the target time.

In FIG. 1, the input and output of the problem are described intuitively by an example. In the database 100, the row direction 102 represents a submit time i, where each row represents the bookings submitted at a certain time slice. The time slice may be represented in a configurable time period such as days, hours, minutes, etc., as may be appropriate to the specific bookings industry being represented in the database 100. In this example, the submit time i 102 is represented in days.

In the database 100, the column direction 104 represents a target time j, where each column represents the bookings targeted at a certain time slice. The time slice in the column direction 104 for the target time j is also represented in days to match the time period of the submit time i. The aggregated row 106 provides a total number of bookings for each column. As time goes by, new data come in rows, and the aggregated results 106 should be updated accordingly. A horizon of 0-6 days ahead is allowed in the database 100.

Take the case for Day 7 (108) as an example. Bookings received for Day 7-Day 13 are 1, 8, 7, 9, 5, 9, 1, respectively. From another point of view, demand for Day 7 (110) were received on Day 1-Day 7, i.e. 5, 8, 8, 5, 1, 2, 1 respectively, the total demand of Day 7 is fully determined by:

(Demand of Day 7)=5+8+8+4+1+2+1=29(112)

This is the aggregated results 106 at the first line in database 100. Note that the real demand is only fixed when there is no possible change on the bookings, which means it won't be available until the final day. The forecast system will base on the available booking information and build the model to predict the future demand.

Take the current date as Day 9 (114 ), it's easy to see that the total bookings targeted before Day 9 are totally deterministic, while those after Day 9, can only be known partly. For instance, on Day 10 (116):

(Demand of Day 10)=9+1+2+9+4+4+X=29+X(116)

where X means possible change of the bookings

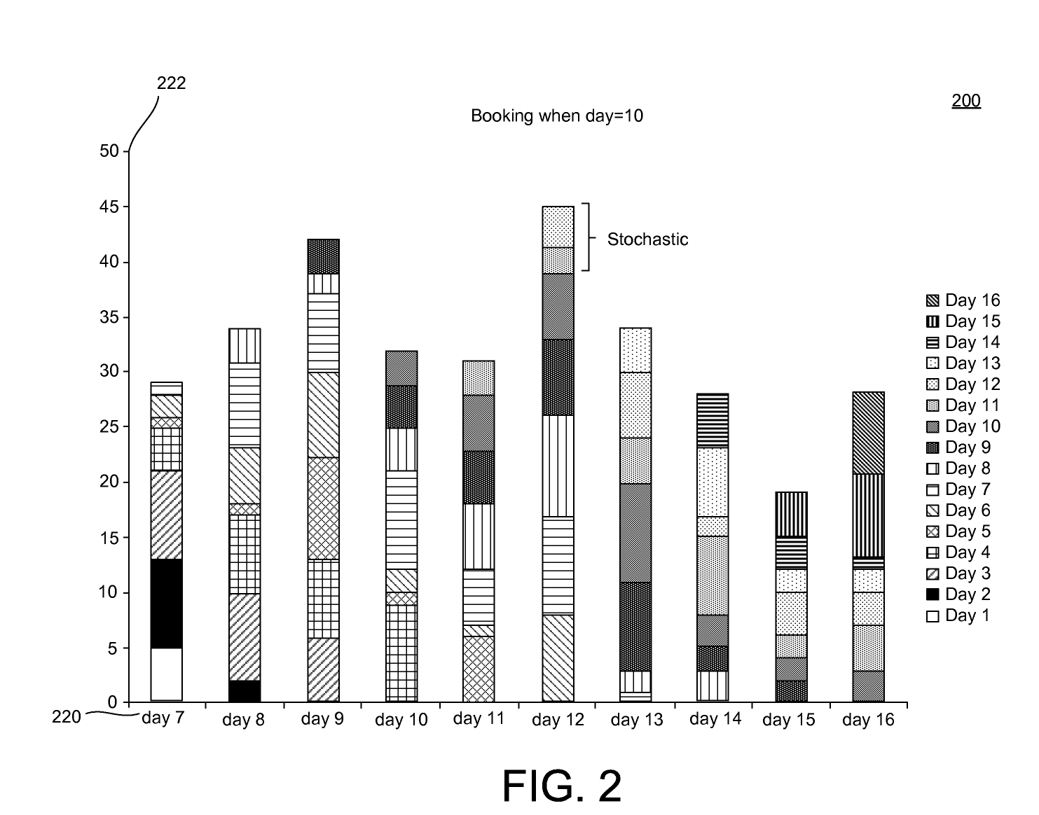

Referring also to FIG. 2, an example chart 200 illustrates the total bookings of each day in aggregated form from the historical bookings with the x-axis 220 representing the day corresponding to the target time j 104 of FIG. 1. The y-axis 222 represents the aggregate number of booking for each day on the x-axis. The aggregate number of bookings corresponds to the aggregate row 106 of FIG. 1. The chart 200 is an equivalent representation of the database 100 of FIG. 1. The total demand for each day is divided into two parts: one is denoted as known (deterministic) bookings, while the other is denoted as forecast bookings (hence stochastic).

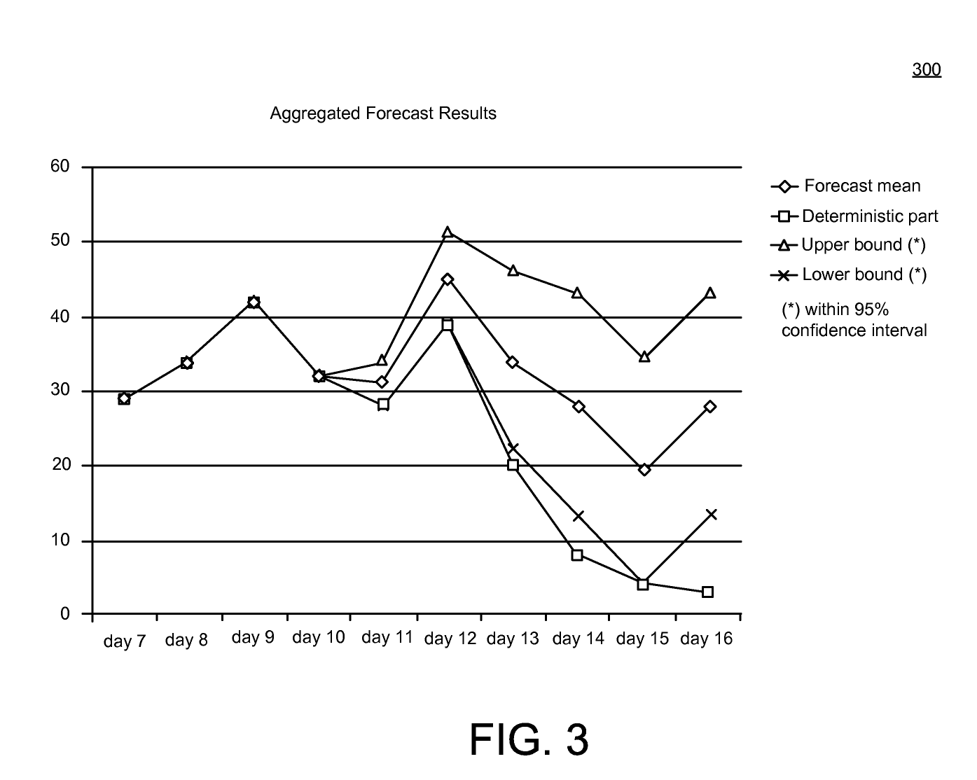

Referring also to FIG. 3, an example chart 300 illustrates the forecast results, which are aggregated from the forecast result of a. The chart 300 illustrates that the confidence level enlarging when the forecast horizon increases, which stands for the number of allowed days between the target day minus the submit day.

The bookings for time slice t (target time) could be submitted (submit time) during the interval [t−r, t−s], where r> s≧0. It is not difficult to find the equivalence of the assumption: at time slice t, bookings can only be submitted for the time slices in [t+s, t+r]. Let yₜ be the total bookings with target time t, and xᵢⱼ be the booking with target time j and submit time i, where (j−i) ∈[s,r], can been seen that yₜ could be represented as follows,

yₜ=Σᵢ₌ₜ₋ᵣ_{^{x}}_{i,t}^{t-s} Equation (1)

In the end of time slice t, we already have {x_{t,t+s}, x_{t,t+s+1}, . . . , x_{t,t+r}}, which are booking for the futures, consequently, the forecast made for the future, i.e., {yₜ₊ₛ, yᵣ₊ₛ₊₁, . . . yₜ₊ᵣ}, should be updated in accordance with new arrival bookings.

Besides historical booking data, some external information associated with submit time i and target time j, could also be incorporated to make more accurate forecast. For example, if the weather forecast says today that next week would be rainy, the bookings submitted at today for the next week may decrease. The external information associated with time slice pair (i, j) is denoted as a column vector bᵢⱼ, each element in which represents an external factor.

Let T be the current time slice. One goal of the system is to update the old forecast results, i.e. , {y_{T+s}, y_{T+s+1}, . . . , y_{T+r}}, after new bookings/external information comes.

In FIG. 1, the input and output of the problem are described intuitively. In the figure, each row 102 represents the bookings submitted at a certain time slice, and each column 104 represents the bookings for a certain time slice. As time goes by, new data come in rows, and the aggregated results 106, i.e. yₜ, should be updated accordingly.

One challenge in booking forecast is that, at a single time slice t, multiple bookings {x_{t,t+s}, x_{t,t+s+1}, . . . , x_{t,t+r}} arrive. Complex correlations exist between submit time as well as target time. These kind of correlations should be taken into consideration when building a model for booking forecast.

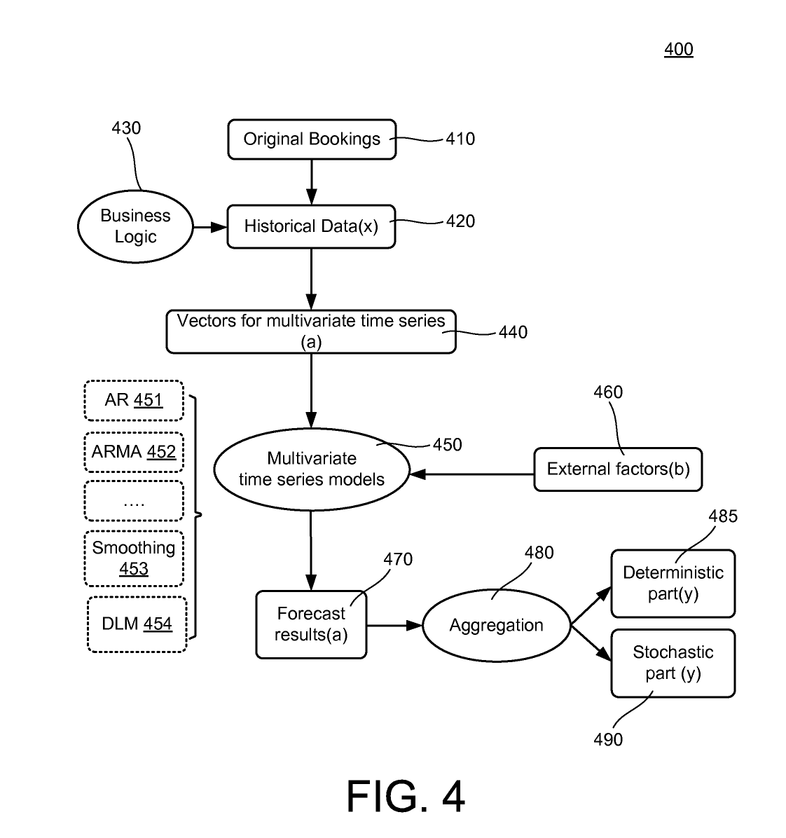

Referring to FIG. 4, an example flowchart illustrates a process 400 for booking forecast. In the process 400, the historical data are converted into a multivariate time series, in which the observed quantity at a single time slice is a vector, i.e., multiple values, rather than a single value observed in a uni-variate time series.

Specifically, the observed vector for a single time slice t, denoted as aₜ ∈ [symbol] ^{r-s+1}, is built as follows:

aₜ=[x_{t,t+s}, x_{t,t+s+1}, . . . , x_{t,t+r}] Equation (2)

Given the historical booking data collected up to time slice T, the process of Algorithm 1 (outlined below) may be used to obtain the booking forecast for the future. Algorithm 1 is also illustrated in flowchart format as the process 400 in FIG. 4.

With respect to process 400, the process starts with the original bookings (410). The original bookings are converted into a matrix of historical data (x) (420). Business logic (430) also may be input into the matrix related to the historical data (x). The historical data may be time series data arranged into a matrix. The matrix of the historical data are converted into a multivariate time series (440), where the observed quantity at a single time slice is a vector, as described in more detail below.

The vectors from the multivariate time series are used to train a multivariate time series model (450). Examples of a multivariate time series model includes AR (451), ARMA (452), Smoothing (453) and a Dynamic Linear Model (DLM) (454). External factors (460) also may be input into the multivariate time series model to account for one or more different types of external influences that may have an effect on the forecast.

The trained multivariate time series model may be used to forecast results (470) and the results may be aggregated (480). The aggregated results include both a deterministic part (485) and a stochastic part (490).

It may not be necessary to update the multivariate time series models every day. For example, in one implementation, upon new bookings arrivals, the multivariate models may be re-trained/updated. Then, the forecast results are calculated based on the re-trained/updated models. In this implementation, the new bookings are leveraged in the training stage.

In another implementation, upon new bookings arrivals, the forecast is first made based on existing multivariate time series models (e.g., models that might have been trained a month ago). In this implementation, the new bookings are leveraged in the forecast stage.

The process 400 is further described below with reference to corresponding Algorithm 1.

Algorithm 1

```
    Input: Historical booking data collected up to time slice T:
    1. Build a₁, a₂,...a_{T} according to Equation (2).
    2. Train some existing multivariate time series model like ARIMA
with data a₁, a₂,...a_{T}.
    3. Make forecast for aₜ where t ∈{T + 1, T+2, ...,T + r − s+1}.
    4. Update the corresponding aggregated results, i.e., yₜ where t ∈{T +
1, T+2, ...,T + r − s+1}, according to Equation (1).
    Output: yₜ where t ∈{T + 1, T+2, ...,T + r − s+1}
```

It is not difficult to verify that all the xs required to compute yₜ for t ∈ {T+1, T+2, . . . , T+r−s+1} are either existing bookings or forecast results, where the former contribute to the deterministic part (485) of forecasting, and the latter contribute to the stochastic part (490). Usually, multivariate time series models output the confidence interval for each x as well, with these intervals the confidence interval for the final aggregated result (yₜ) (480) could also be obtained.

Using multivariate time series techniques for booking forecast problem has multiple advantages. Uni-variate time series models could be extended to the multivariate case. Some common properties for uni-variate time series , like trend, seasonality, could be adapted to multivariate time series as well. Multivariate times series models could exploit the complex correlations in booking forecast problem.

Taking multivariate AR(1) model for example:

aₜ=Haₜ₋₁+Eₜ

where H ∈ R^{(r-s+1)×(r-s+1)} and Eₜ are white noise. After expanding the matrix-vector multiplication Haₜ₋₁, it can be seen that xᵢⱼ is a linear combination of {x_{i-1,i-1+r}, x_{i-1,i+r}, . . . , x_{i-1,i-1+s}} plus some noise. Thus, bookings submitted at time slice i for time slice j relates not only to the submit time slice i−1, but also to the target time slice. Therefore, multivariate time series techniques fit the purpose in modeling the complex correlations in booking forecast problem.

To incorporate external factors into the model (460), each booking xᵢⱼ is decomposed into two parts, the first part comes from multivariate times series model in the basic framework, and the second part comes from the external factors (460) which could be represented as a linear combination of b. In terms of multivariate time series, we have

aₜ=uₜ+Bₜw Equation (3)

where uₜ follows some multivariate time series model like multivariate ARIMA, and B is a stacking of bᵢⱼ:

$${B}_{t} = [ \begin{matrix}{b}_{t , t + s}^{T} \\ {b}_{t , t + s + 1}^{T} \\ ⋮ \\ {b}_{t , t + r}^{T}\end{matrix} ]$$

and w acts like a weights in regression analysis, which is obtained during the training phrase.

Forecast for the future could be made according to Equation (3). Note that elements in Bₜ that are not available may be replaced by the forecast values made at the current time slice T. The entire workflow for the framework with external factors are shown in process 400 of FIG. 4.

In the framework presented above, the choice for multivariate time series models are flexible. In one implementation, as discussed above, the multivariate time series model may need re-estimating when new booking data arrive. However, for some particular multivariate time series models, re-estimation could be circumvented by taking the online update technique. In one example implementation, a Dynamic Linear Model (DLM), such as DLM 454 of FIG. 4, is chosen as the multivariate time series model. Due to its probabilistic nature, Bayesian Inference could be carried out and an online update may be made in a posterior to prior transfer manner.

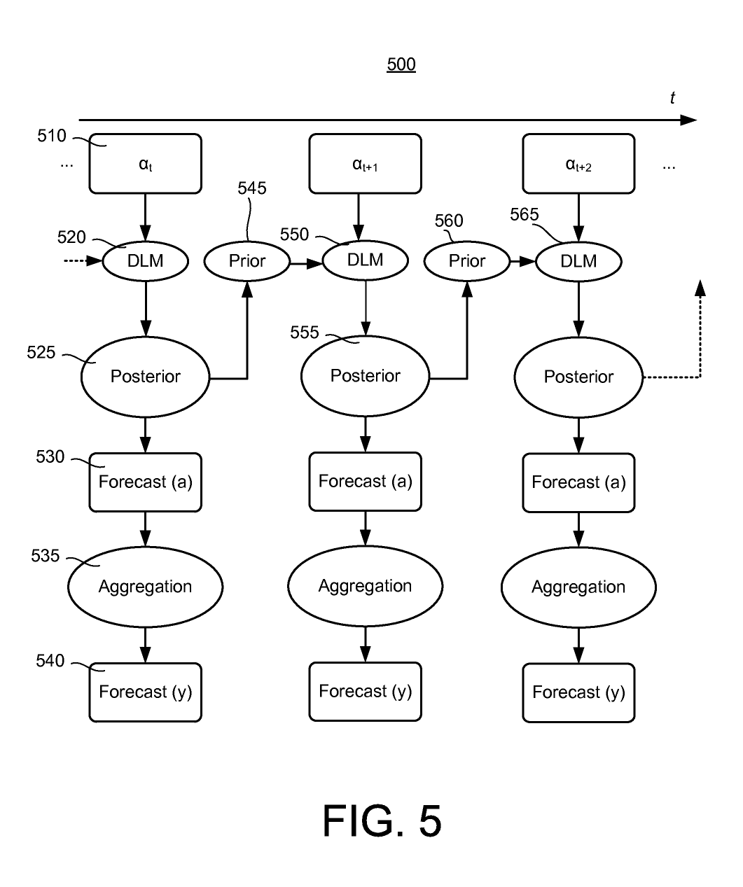

Referring to FIG. 5, an example flowchart 500 illustrates a Bayesian online update for booking forecast. In a Dynamic Linear Model (DLM), the multivariate vector aₜ (510) is encoded within another variable zₜ by the DLM (520). Note that the relationship between aₜ and zₜ is not necessary an one to one mapping in that zₜ may contain variables for other time slices like aₜ₋₁, depending on the relationship to be modeled. In the DLM (520), z relates a latent variable uₜ, and uₜ only relates to uₜ₋₁ as described in the following equations:

zₜ=Fₜuₜ+Eₜ Equation (4)

uₜ=Gₜuₜ₋₁+ηₜ Equation (5)

where ηₜ and ηₜ are drawn from two known Multivariate Normal distributions,
Et ∈ N (0|0, V)
ηt ∈ N(0|0, W)

In the system, Fₜ and Gₜ are known matrices which are re-organizations of the booking historical data and external factors, and V, W are given parameters.

Given that new booking data arrives at time slice T , i.e. aₜ, the goal of the training phrase is to estimate the posterior (525) of the latent variables uₜ where t≦T, e.g., mean and variance, so as to make forecast for zₜ where t>T. Since aₜ is encoded in zₜ, we could get the estimation for aₜ by decoding zₜ.

A good property for DLM model is that, the posterior for time slice t only depend on the posterior for the previous time slice t−1 (see From Equation. (5)). As a consequence, when new booking data arrives at time slice T, it is not necessary to re-estimate the posterior for uₜ where t≦T−1. Instead, the previous estimation for u_{T-1} could be used directly to estimate the posterior of U_{T}.

Suppose the posterior for u_{T-1} is p(u_{T-1}), the posterior for u_{T} is exactly the posterior for the following probabilistic model:

z_{T}˜N(·|F_{T}u_{T}, V)

u_{T}−N(·|G_{T}u_{T-1}, W)

u_{T-1}˜p(u_{T-1}) Equation 6

FIG. 5 illustrates the entire working flow 500 for the online updating system. For example, the posterior (525) is calculated by the DLM 520 and is used in the forecast for a (530), which is then aggregated (535) and used for the forecast of y (540). The posterior (525) is also input as the prior posterior (545) to for the next DLM (550). The DLM (550) results in the posterior (555), which becomes the prior posterior (560) used by the next DLM (565). As discussed above, in this manner, when new booking data arrives, it is not necessary to re-estimate posterior because the prior posterior can be used.

Algorithm 2, described below, summarizes the workflow 500 of FIG. 5:

Algorithm 2

```
    posterior ← initial prior for u₁.
    for T = 2,... do
        prior_{t+1} ← posterior_{t}
        posterior_{t+1} ← prior_{t+1} + a_{t+1} of Equation (6).
        Update the forecast result for aₜ where t ∈ {T + 1, T + 2, . . . ,
T + r − s + 1}.
        Update the corresponding aggregated results yₜ.
    end for.
```

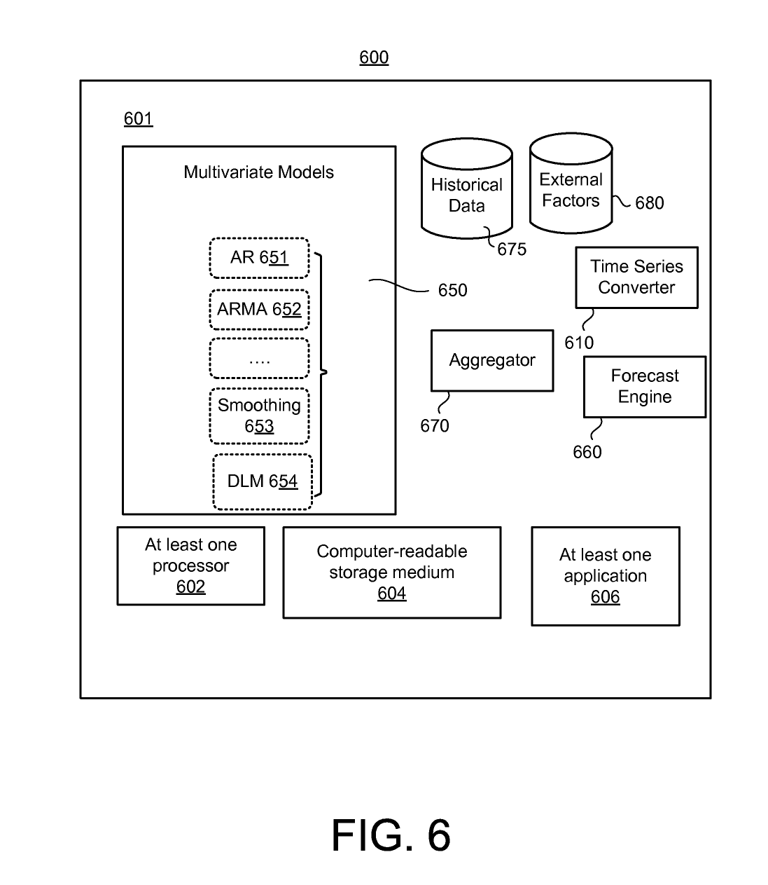

FIG. 6 is an example block diagram of an example system 600 for a booking based demand forecast problem. The system 600 includes at least one computing device 601 and the computing device 601 includes the forecast engine 106 and the network builder 110 of FIG. 1.

The at least one computing device 601 includes at least one processor 602, a non-transitory computer-readable storage medium 604, and at least one application 606. The computing device 601 may include any type of computing device including, for example, a server, a blade server, a desktop, a laptop, or any other computing device. The computing device 601 may include multiple computing devices, such as, multiple servers, that are operably coupled and configured to host the components of the system across the multiple computing devices. The computing device 601 may be networked to other computing devices (not shown) such that the systems on the computing device 601 may send and receive information across a network (not shown), such as the Internet, a wide area network and/or a local area network.

Thus, the at least one processor 602 may represent two or more processors executing in parallel, and a non-transitory computer-readable storage medium 604 may represent virtually any non-transitory medium that may be used to store instructions for executing the components of system 600, including the at least one application 606. Multiple processors also may be referred to as multi-core processors or multi-processor core environment. The processor 602 may be a hardware processor, including a micro-processor.

The at least one processor 602 may be configured to execute instructions stored on the computer-readable storage medium 604 that, when executed, cause the at least one processor 602 to implement the time series converter 610, the multivariate time series models 650, the forecast engine 660 and the aggregator 670.

The time series converter 610 is configured to convert historical time series data 675 into a multivariate time series, where the observed quantity at a single time slice is a vector. The multivariate time series models 650 are configured to use the processor 602 to train a selected model using the converted multivariate time series. The multivariate time series models 650 include various different models, such as AR 651, ARMA 652, Smoothing 653 and DLM 654. A particular model may be selected depending on the type of time series data being used and/or the particular domain for the time series data. The multivariate time series model 650 also may receive external factors 680 as input for the training of the selected model.

The forecast engine 660 is configured to forecast results using the multivariate time series model and the aggregator 670 is configured to aggregate the results. As discussed above, the aggregated results may include a deterministic portion and a stochastic portion.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer-implemented method for a booking based demand forecast problem including executing instructions stored on a non-transitory computer-readable storage medium, the method comprising:
converting time series data into a multivariate time series;
training a multivariate time series model using the converted multivariate time series;
forecasting results using the multivariate time series model; and
aggregating the results.

2. The computer-implemented method of claim 1 further comprising inputting one or more external factors into the multivariate time series model.

3. The computer-implemented method of claim 1 wherein the aggregated results include a deterministic portion and a stochastic portion.

4. The computer-implemented method of claim 1 further comprising selecting the multivariate time series model from a plurality of multivariate time series models.

5. The computer-implemented method of claim 1 wherein the multivariate time series model is a Dynamic Linear Model (DLM).

6. The computer-implemented method of claim 5 wherein the DLM uses a previous estimation of a posterior of variables to estimate a current posterior of the variables.

7. The computer-implemented method of claim 5 further comprising updating the results using Bayesian Inference.

8. A computer program product for a booking based demand forecast problem, the computer program product being tangibly embodied on a non-transitory computer-readable storage medium and comprising instructions that, when executed by at least one computing device, are configured to cause the at least one computing device to:
convert time series data into a multivariate time series;
train a multivariate time series model using the converted multivariate time series;
forecast results using the multivariate time series model; and
aggregate the results.

9. The computer program product of claim 8 further comprising instructions that, when executed by at least one computing device, are configured to cause the at least one computing device to input one or more external factors into the multivariate time series model.

10. The computer program product of claim 8 wherein the aggregated results include a deterministic portion and a stochastic portion.

11. The computer program product of claim 8 further comprising instructions that, when executed by at least one computing device, are configured to cause the at least one computing device to selecting the multivariate time series model from a plurality of multivariate time series models.

12. The computer program product of claim 8 wherein the multivariate time series model is a Dynamic Linear Model (DLM).

13. The computer program product of claim 12 further comprising instructions that, when executed by at least one computing device, are configured to cause the at least one computing device to updating the results using Bayesian Inference.

14. A system for a booking based demand forecast problem, the system comprising:
at least one memory including instructions; and
at least one processor that is operably coupled to the at least one memory and that is arranged and configured to execute the instructions that, when executed, cause the at least one processor to implement a time series converter, a multivariate times series model, a forecast engine, and an aggregator, wherein:
the time series converter is configured to convert time series data into a multivariate time series,
the multivariate time series model is configured to be trained using the converted multivariate time series,
the forecast engine is configured to forecast results using the multivariate time series model, and
the aggregator is configured to aggregate the results.

15. The system of claim 14 wherein the multivariate time series model is configured to receive one or more external factors and to be trained using the converted multivariate time series and the external factors.

16. The system of claim 14 wherein the aggregated results include a deterministic portion and a stochastic portion.

17. The system of claim 14 wherein the multivariate time series model is selected from a plurality of multivariate time series models.

18. The system of claim 14 wherein the multivariate time series model is a Dynamic Linear Model (DLM).

19. The system of claim 18 wherein the DLM uses a previous estimation of a posterior of variables to estimate a current posterior of the variables.

20. The system of claim 18 wherein the forecast engine is configured to update the results using Bayesian Inference.
